(19) United States
(12) Patent Application Publication
(10) Pub. No.: US 2026/0277391 A1
(43) Pub. Date: Sep. 17, 2026

(54) INFORMATION PROCESSING APPARATUS, INFORMATION PROCESSING METHOD, AND STORAGE MEDIUM

(71) Applicant: Canon Kabushiki Kaisha, Tokyo (JP)

(72) Inventor: HARUKI SATO, Kanagawa (JP)

(21) Appl. No.: 19/545,169

(22) Filed: Feb. 20, 2026

(30) Foreign Application Priority Data
Mar. 17, 2025 (JP) 2025-042723

(51) Int. Cl. G06F 3/04817; G06V 30/41; H04N 1/21

(52) U.S. Cl. CPC G06F 3/04817; G06V 30/41; H04N 1/2166

(57) ABSTRACT

An information processing apparatus includes: a reception unit configured to receive electronic data of an image representing a document selected by a user; a first obtaining unit configured to obtain information indicating a form of exchange of the document; a second obtaining unit configured to obtain a resolution of the image and a number of tones of the image from the electronic data; and a display control unit configured to perform a process of displaying the form of exchange, the resolution, and the number of tones to the user.

### BACKGROUND

### Field of the Technology

The present disclosure relates to processing related to electronic data of a document.

### Description of the Related Art

Document management systems that computerize and manage documents such as business forms have been used. In the document management systems, the method of managing a document may vary depending on the form of exchange of the document to be managed. For this reason, the document management systems may require inputting the form of exchange of the document. To address this, Japanese Patent Laid-Open No. 2023-137077 discloses a method that identifies the form of exchange of a document based on attribute information of electronic data representing the document.

### SUMMARY

An information processing apparatus of the present disclosure includes: a reception unit configured to receive electronic data of an image representing a document selected by a user; a first obtaining unit configured to obtain information indicating a form of exchange of the document; a second obtaining unit configured to obtain a resolution of the image and a number of tones of the image from the electronic data; and a display control unit configured to perform a process of displaying the form of exchange, the resolution, and the number of tones to the user.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a configuration of a document management system;

FIG. 2 is a diagram illustrating a hardware configuration of a user terminal;

FIGS. 3A and 3B are diagrams illustrating a hardware configuration of a document management server;

FIG. 4 is a diagram illustrating functional arrangements of the user terminal and the document management server;

FIG. 5 is a sequence chart illustrating a flow of processing between the apparatuses in the document management system;

FIG. 6 is a diagram illustrating an example of an electronic transaction data transmission screen;

FIG. 7 is a flowchart for describing an electronic transaction data analysis process;

FIG. 8 is a diagram illustrating an example of an electronic transaction data registration screen;

FIG. 9 is a diagram illustrating an example of the electronic transaction data registration screen;

FIG. 10 is a diagram illustrating an example of the electronic transaction data registration screen;

FIG. 11 is a diagram illustrating an example of the electronic transaction data registration screen;

FIG. 12 is a diagram illustrating an example of the electronic transaction data registration screen; and

FIG. 13 is a diagram illustrating an example of the electronic transaction data registration screen.

### DESCRIPTION OF THE EMBODIMENTS

Embodiments of the technique of the present disclosure will be described below using the drawings. Note that the following embodiments do not limit the technique of the present disclosure according to the claims, and not all the combinations of the features described in the following embodiments are necessarily essential for the solution to be provided by the technique of the present disclosure.

### First Embodiment

For some of documents required to be stored by law, so-called scanner storage is sometimes permitted in which a paper document is stored in the form of electronic data obtained by reading the paper document with a scanner or the like, instead of storing the paper document. However, in order to perform the so-called scanner storage of a document whose form of exchange was paper into electronic data, the image quality of the electronic data to be stored must satisfy requirements specified under a law or the like. Also, for other paper documents too, the user may desire to store them in the form of electronic data with appropriate image quality, instead of in the form of paper documents, so that they can be easily checked after being stored. However, with the method disclosed in Japanese Patent Laid-Open No. 2023-137077, the user cannot easily check whether electronic data selected by the user for the scanner storage satisfies desired storage requirements.

The technique of the present disclosure enables a user to easily check whether electronic data representing a document selected by the user satisfies storage requirements.

### System Configuration

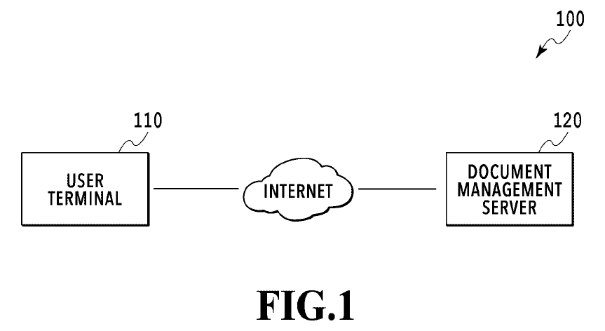

FIG. 1 is a diagram illustrating an example of a configuration of a document management system 100 in a first embodiment. The document management system 100 includes a user terminal 110 and a document management server 120. While the user terminal 110 and the document management server 120 are configured to communicate with each other through the Internet, the user terminal 110 and the document management server 120 may be configured to communicate with each other through a local network within a company or the like. The user terminal 110 is an information processing apparatus that is used by the user, such as a smartphone or a personal computer. The document management server 120 is an information processing apparatus that operates a document management service, such as a server computer.

### Hardware Configuration of User Terminal

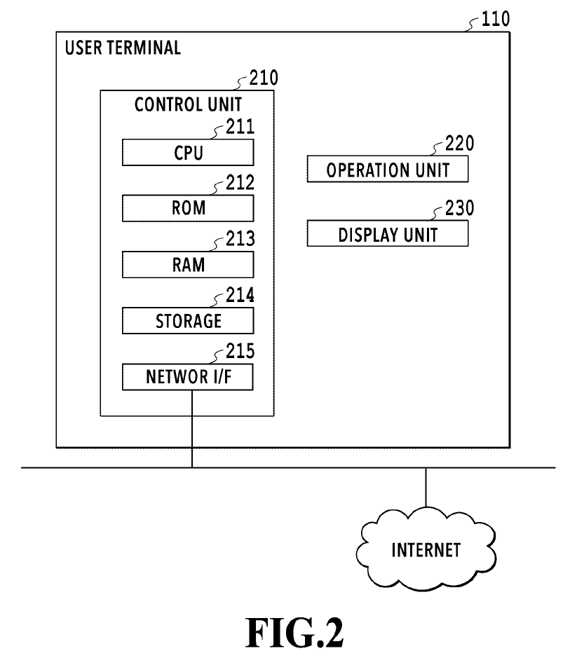

FIG. 2 is a hardware configuration diagram of the user terminal 110. The user terminal 110 includes a control unit 210, an operation unit 220, and a display unit 230.

The control unit 210 includes a central processing unit (CPU) 211, a read-only memory (ROM) 212, a random-access memory (RAM) 213, a storage 214, and a network interface (I/F) 215. The CPU 211 reads out a control program stored in the ROM 212 and executes various processes to control the operation of the whole user terminal 110. The RAM 213 is a storage unit to be used as temporary storage areas such as a main memory and a work area for the CPU 211. In the present embodiment, a single CPU 211 uses a single memory (RAM 213 or storage 214) to execute the process of each step in a sequence to be described later. However, the configuration is not limited to this. For example, a plurality of CPUs and a plurality of RAMs or storages may be caused to cooperate with each other to execute the process of each step. The storage 214 is a large-capacity storage unit that stores images and various programs. The network I/F 215 is an interface for connecting the user terminal 110 to the Internet. The user terminal 110 communicates with other apparatuses via the network I/F 215 to transmit and receive various pieces of information.

The operation unit 220 is a mouse, a keyboard, and/or the like and accepts the user's operations, such as inputs and instructions. The display unit 230 is a display and displays screens. The display unit 230 and the operation unit 220 may be formed integrally with each other, like a touch panel.

### Hardware Configuration of Document Management Server

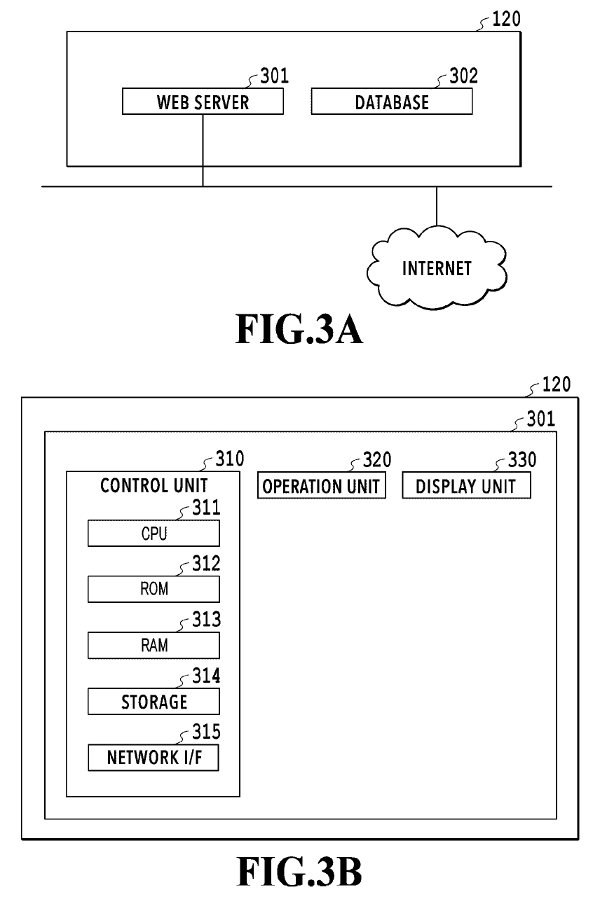

FIG. 3A is a diagram illustrating an example of a configuration of the document management server 120. The document management server 120 includes a web server 301 and a database 302. The web server 301 is an information processing server that serves as a contact point for communicating with the user terminal 110. The database 302 stores electronic transaction data transmitted from the user terminal 110. Also, the database 302 manages information of the stored electronic transaction data itself, such as the electronic transaction data's file name and timestamp, and information inside the electronic transaction data, such as business operators' names and the billing amount.

FIG. 3B is a hardware configuration diagram of the document management server 120. The web server 301 included in the document management server 120 includes a control unit 310, an operation unit 320, and a display unit 330. The control unit 310, the operation unit 320, and the display unit 330 are similar to the control unit 210, the operation unit 220, and the display unit 230 of the user terminal 110, and description thereof will therefore be omitted. Note that the document management server 120 may be a system configured of a plurality of server apparatuses. Specifically, the information processing apparatus that implements the document management server 120 may include a system configured of multiple apparatuses that share roles.

### Functional Arrangement of Entire System

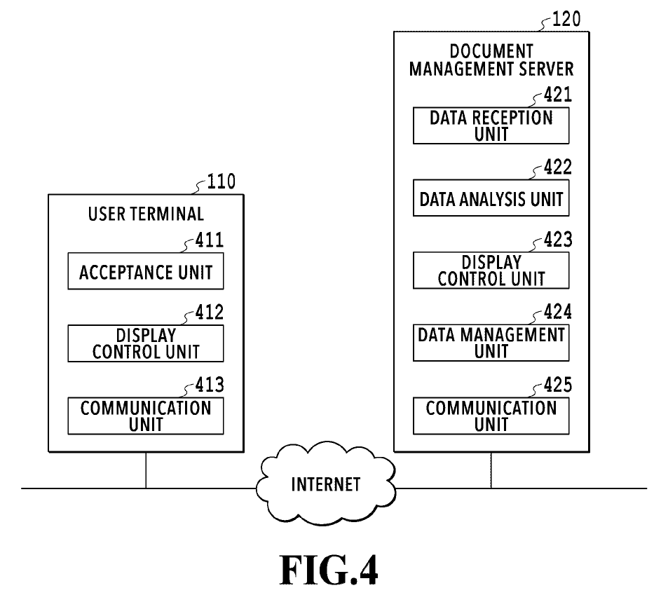

FIG. 4 is a diagram illustrating functional arrangements of the user terminal 110 and the document management server 120. The user terminal 110 includes an acceptance unit 411, a display control unit 412, and a communication unit 413.

The acceptance unit 411 accepts an instruction to change the contents of information displayed on the display unit 230 or to perform a process from the user of the user terminal 110.

The display control unit 412 displays a screen corresponding to screen data transmitted from the document management server 120 on the display unit 230. Also, the display control unit 412 updates the contents of the screen displayed on the display unit 230 based on the content of the instruction accepted by the acceptance unit 411 and data received by the communication unit 413.

The communication unit 413 transmits the content accepted by the acceptance unit 411 from the user to the document management server 120 and receives data returned as a response.

The document management server 120 includes a data reception unit 421, a data analysis unit 422, a display control unit 423, a data management unit 424, and a communication unit 425.

The data reception unit 421 receives electronic transaction data from the user terminal 110.

The data analysis unit 422 analyzes whether the electronic transaction data received by the data reception unit 421 satisfies the requirements for so-called scanner storage. The data analysis unit 422 has at least the function of a determination unit that determines whether the form of exchange of the document corresponding to the electronic transaction data is paper or electronic, and the function of an obtaining unit that obtains necessary information from attribute information of the electronic transaction data. Further, the data analysis unit 422 includes an extraction unit that recognizes a group of character strings in the image and extracts a character string indicating the issue date from the recognized group of character strings.

The display control unit 423 generates screen data for displaying a screen based on an instruction from the user terminal 110 and transmits the screen data to the user terminal 110 via the communication unit 425 to cause the user terminal 110 to display the generated screen.

The data management unit 424 outputs and updates pieces of electronic transaction data stored in the database 302 and newly registers pieces of electronic transaction data. Also, the data management unit 424 obtains and updates pieces of document information stored in the database 302 and adds pieces of document information based on the contents of instructions given from the user terminal 110 via the communication unit 425.

The CPUs of the apparatuses implement the functional units illustrated in FIG. 4 by executing predetermined programs, but the present disclosure is not limited to this. In an alternative example, hardware such as a graphics processing unit (GPU) for speeding up computation or a field programmable gate array (FPGA) may be utilized. Each functional unit may be implemented by software and hardware, such as a dedicated integrated circuit (IC), cooperating with each other, or some or all of the functions may be implemented solely by hardware.

### Flow of Processing between Apparatuses

In the present embodiment, the issuer of an invoice is a business operator conducting a transaction involving selling a product or a service to a client. Suppose that the issuer of the invoice is a business operator A. On the other hand, the billing destination is a business operator who purchased the product or the service from the business operator A, and the billing destination receives the invoice from the business operator A. Suppose that the billing destination of the invoice is a business operator B. Each business operator may be an individual or an entity such as a company or a corporation.

In a case where the business operator A conducts a transaction with the business operator B, the business operator A creates an invoice for the business operator B. The invoice may be a paper invoice output from a printing apparatus or an electronic invoice generated in the Portable Document Format (PDF) or the like. The person in charge at the business operator A sends the created invoice to the business operator B. The person in charge at the business operator B receives the invoice from the business operator A.

The form of exchange of a document in the present embodiment refers to information indicating the medium of the document at the time of being delivered or received between the issuer of the document (business operator A) and the recipient of the document (business operator B) or the means by which the document is delivered by the issuer or received by the recipient. In a case where a paper document is physically delivered or received by hand, mail, or the like, the form of exchange of this document is "paper." In a case where a computerized document is electronically delivered or received through a network by email, a cloud service, or the like, the form of exchange of this document is "electronic." For example, in the case of an electronic invoice, the issuer may attach the invoice to an email or the like and transmit the electronic invoice directly to the billing destination. In this case, the form of exchange of the document (invoice) is "electronic." Alternatively, the issuer may send a paper invoice printed by a printing apparatus to the billing destination by fax, mail, or hand. In this case, the form of exchange of the document (invoice) is "paper."

In a case where the person in charge at the business operator B, who receives a document, receives an electronic document, whose form of exchange is "electronic," the electronic data of the document received from the business operator A is stored as is in the user terminal 110 or a cloud storage as electronic transaction data. Alternatively, in a case where the person in charge at the business operator B receives a paper document, whose form of exchange is "paper," the person in charge reads the paper document with a reading apparatus, such as a scanner. Then, the person in charge at the business operator B stores the electronic data of the scan image obtained by that scan and representing the document in the user terminal 110 or a cloud storage as electronic transaction data.

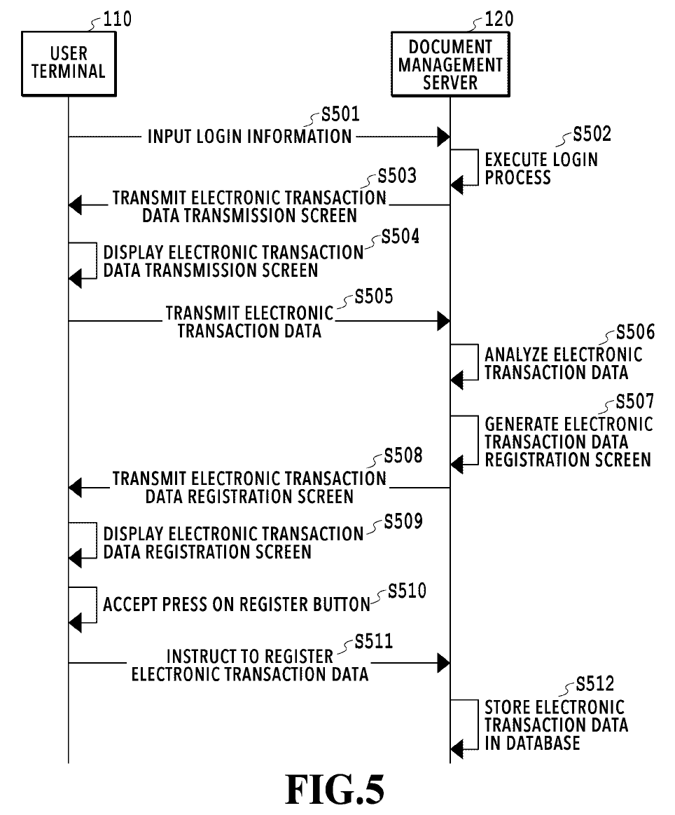

FIG. 5 is a sequence chart illustrating a flow of processing between the user terminal 110 and the document management server 120 included in the document management system 100 in the present embodiment. In the following description, an invoice will be described as an example of the document. Among the steps illustrated in FIG. 5, the steps to be executed by the user terminal 110 are implemented by expanding programs stored in the ROM 212 or the storage 214 of the user terminal 110 onto the RAM 213 and executing them with the CPU 211. The steps to be executed by the document management server 120 are implemented by expanding programs stored in a ROM 312 or a storage 314 of the document management server 120 onto a RAM 313 and executing them with a CPU 311. Alternatively, the functions of some or all of the steps in FIG. 5 may be implemented with hardware such as an application-specific integrated circuit (ASIC) or an electronic circuit. The symbol "S" in the description of each process means a step in the sequence. This applies also to the subsequent flowchart.

In the sequence in FIG. 5, a person in charge at the business operator B, who receives an invoice being an example of the document, is a user of the document management service operated by the document management server 120. However, a person in charge at the business operator A, who issues the invoice, may be a user of the document management service. In that case, it is assumed that the person in charge at the business operator A has stored a copy of the issued invoice in the user terminal 110 or a cloud storage.

In S501, the CPU 211 of the user terminal 110 accepts an operation to log into the document management server 120 from the user. For example, the person in charge at the business operator B receives the invoice from the business operator A and stores electronic transaction data of the invoice, and thereafter uses the user terminal 110 to access the document management server 120 and input their user name and password to attempt to log into the document management service.

In S502, the CPU 311 of the document management server 120 receives the user name and the password from the user terminal 110 and performs a login process that judges whether the user operating the user terminal 110 is a registered user from the received user name and password. If judging that the user operating the user terminal 110 is not a registered user, the document management server 120 displays an error screen on the user terminal 110.

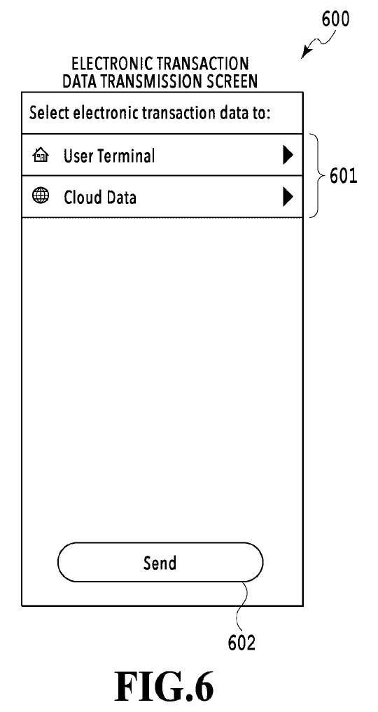

If judging that the user of the user terminal 110 is a registered user, then in S503, the CPU 311 of the document management server 120 transmits screen data for displaying an electronic transaction data transmission screen 600 (see FIG. 6) to the user terminal 110.

In S504, the CPU 211 of the user terminal 110 displays the electronic transaction data transmission screen 600 (see FIG. 6) on the display unit 230.

FIG. 6 is a diagram illustrating an example of the electronic transaction data transmission screen 600. A file selection section 601 is an area where the user selects electronic transaction data to transmit. The user who is the person in charge at the business operator B operates the user terminal 110 to select a location where pieces of electronic transaction data are stored on the electronic transaction data transmission screen 600, and selects a piece of electronic transaction data to transmit as a candidate to register in the document management server 120 from the selected storage location.

In S505, in response to accepting a press on a send button 602 included in the electronic transaction data transmission screen 600, the CPU 211 of the user terminal 110 transmits the piece of electronic transaction data selected by the user to the document management server 120.

In S506, the CPU 311 of the document management server 120 receives the electronic transaction data transmitted from the user terminal 110 and analyzes the received electronic transaction data.

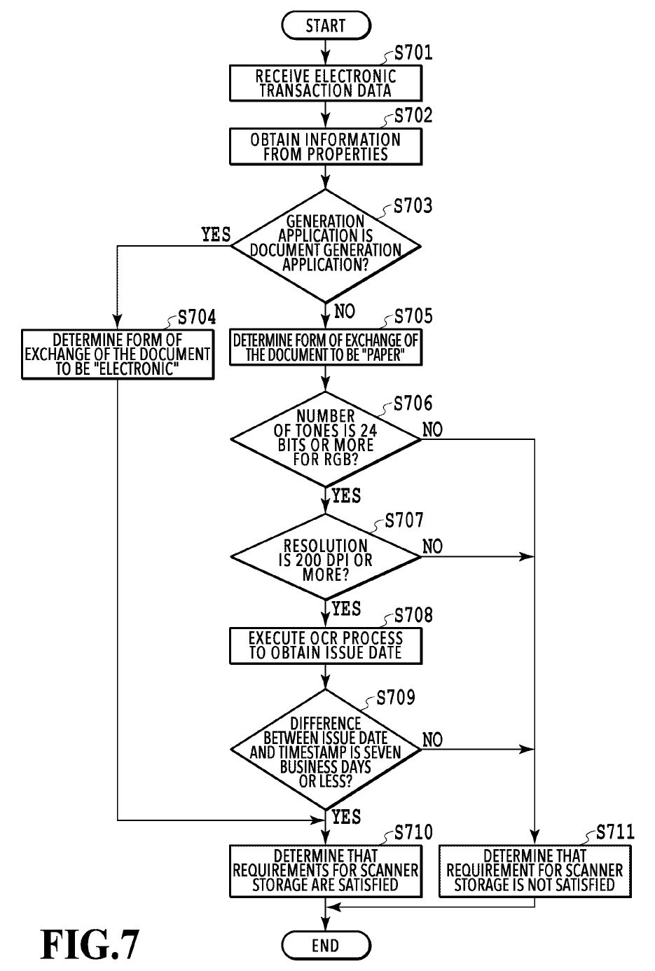

FIG. 7 is a flowchart for describing details of an electronic transaction data analysis process executed by the document management server 120. The steps in FIG. 7 are implemented by expanding programs stored in the ROM 312 or the storage 314 of the document management server 120 onto the RAM 313 and executing them with the CPU 311. Also, the functions of some or all of the steps in FIG. 7 may be implemented with hardware such as an ASIC or an electronic circuit.

In S701, the CPU 311 of the document management server 120 receives electronic transaction data to be analyzed. In the present embodiment, the electronic transaction data to be analyzed is the electronic transaction data selected by the user on the user terminal 110 and transmitted in S505.

In S702, the CPU 311 of the document management server 120 obtains information from the attribute information of the electronic transaction data to be analyzed. The present embodiment will be described on the assumption that the attribute information is information on properties set on the file representing the electronic transaction data. Also, in the present embodiment, information on the generation application, the number of tones, the resolution, and the timestamp information are obtained from the properties.

In S703, the CPU 311 of the document management server 120 obtains information on the application which generated the electronic transaction data to be analyzed (generation application), and judges whether the generation application is a document generation application. For example, a document generation application may be an application which generates PDF data.

If judging that the generation application is a document generation application (YES in S703), the document management server 120 proceeds to S704. In S704, the CPU 311 of the document management server 120 determines that the form of exchange of the document represented by the electronic transaction data to be analyzed is "electronic" and proceeds to S710. In S710, the CPU 311 of the document management server 120 determines that the electronic transaction data to be analyzed satisfies the requirements for scanner storage, and terminates the analysis process.

On the other hand, if judging that the generation application is an application other than a document generation application or unknown (NO in S703), the document management server 120 proceeds to S705.

In S705, the CPU 311 of the document management server 120 determines that the form of exchange of the document represented by the electronic transaction data is "paper." Note that in the present embodiment, the form of exchange of the electronic transaction data is judged from the generation application included in the properties of the electronic transaction data, but the method of judging the form of exchange is not limited. The form of exchange may be determined by a different method. For example, the document management server 120 may let the user select "paper" or "electronic" as the form of exchange, and proceed to S705 if the form of exchange selected by the user is "paper" and proceed to S704 if the form of exchange selected by the user is "electronic."

The document management server 120 executes the processes of S706 to S709 below if the form of exchange of the document is "paper."

In S706, the CPU 311 of the document management server 120 judges from the properties of the electronic transaction data to be analyzed whether or not the number of color tones of the image represented by the electronic transaction data to be analyzed is a predetermined value or more. In the present embodiment, a requirement for scanner storage is 24 bits or more for RGB, which is a legal requirement in Japan. Specifically, in the case where the form of exchange of the document represented by the electronic transaction data is "paper," it is judged whether the electronic transaction data was generated by scanning the paper document based on 256 tones or more as the number of tones for each of red, green, and blue. The document management server 120 proceeds to S707 if judging that the number of tones is 24 bits or more for RGB (YES in S706). Otherwise (NO in S706), the document management server 120 proceeds to S711. In S711, the CPU 311 of the document management server 120 judges that the electronic transaction data to be analyzed does not satisfy a requirement for scanner storage, and terminates the process.

In S707, the CPU 311 of the document management server 120 judges from the properties of the electronic transaction data to be analyzed whether or not the resolution of the image represented by the electronic transaction data to be analyzed is a predetermined value is more. In the present embodiment, whether the resolution is 200 dpi or more, which is a legal requirement for scanner storage in Japan, is judged. Specifically, in the case where the form of exchange of the electronic transaction data is "paper," it is judged whether the electronic transaction data was generated by scanning the paper document at a resolution of 200 dpi or more. If judging that the resolution is 200 dpi or more (YES in S707), the document management server 120 proceeds to S708. Otherwise (NO in S707), the document management server 120 proceeds to S711 and judges that the electronic transaction data to be analyzed does not satisfy a requirement for scanner storage, and terminates the process.

In S708, the CPU 311 of the document management server 120 performs a character recognition process, such as optical character recognition (OCR), on the image represented by the electronic transaction data to be analyzed. Then, the document management server 120 extracts a character string indicating the issue date from the group of character strings recognized by the character recognition process.

In S709, the CPU 311 of the document management server 120 judges whether or not the difference between the issue date obtained in S708 and the date of the timestamp included in the properties of the electronic transaction data to be analyzed is a predetermined number of days or less. In the present embodiment, the predetermined number of days is 7 business days. If the issue date of the invoice cannot be obtained or the difference between the dates is 8 business days or more (NO in S709), the document management server 120 proceeds to S711. As described earlier, the document management server 120 judges that the electronic transaction data to be analyzed does not satisfy a requirement for scanner storage, and terminates the process.

If the difference between the dates is 7 business days or less (YES in S709), the document management server 120 proceeds to S710. In S710, the CPU 311 of the document management server 120 judges that the received electronic transaction data satisfies the requirements for scanner storage, and terminates the analysis process.

Incidentally, in a case where the requirements for scanner storage are changed, the criteria for the judgments in S706, S707, and S709 may be changed as appropriate according to the changed requirements. Also, in the present embodiment, an example has been described in which the judgment criteria are set in compliance with the requirements for storage specified under a law of Japan, but the judgment criteria may be changed to comply with the requirements for storage in the country in which the user is present. Also, in a case where other storage rules such as the company regulations exist, judgment criteria that are stricter than the legal requirements may be employed. Referring back to FIG. 5, the description of the sequence chart will now be resumed.

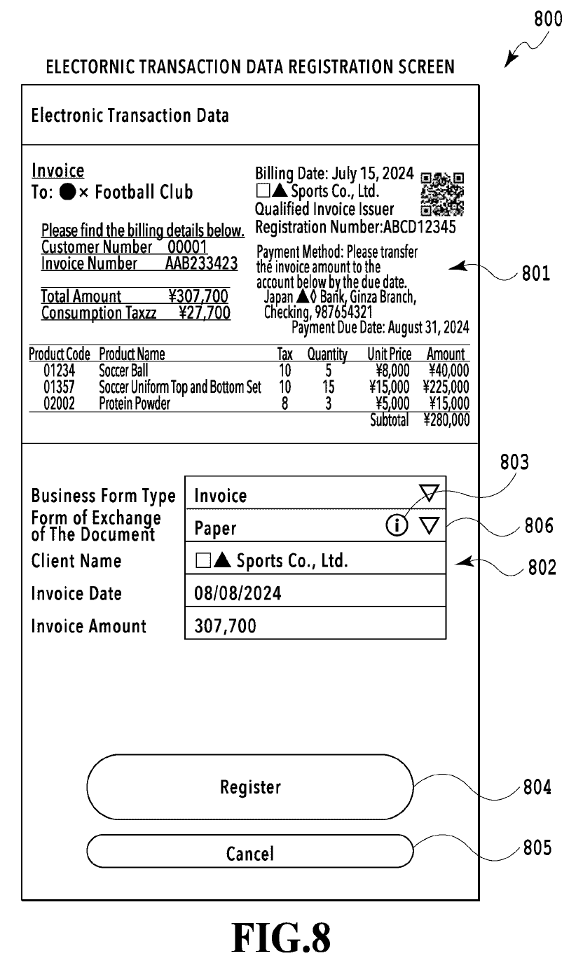

In S507, the CPU 311 of the document management server 120 generates the screen data of an electronic transaction data registration screen 800 (see FIG. 8) based on the analysis result obtained by the process in the flowchart of FIG. 7.

In S508, the CPU 311 of the document management server 120 transmits the screen data generated in S507 the user terminal 110.

In S509, the CPU 211 of the user terminal 110 displays the electronic transaction data registration screen 800 (see FIG. 8) based on the screen data received from the document management server 120.

FIG. 8 is a diagram illustrating an example of the electronic transaction data registration screen 800. A document image display area 801 in the electronic transaction data registration screen 800 is an area to display a document image represented by electronic transaction data. In a case where the form of exchange is "paper," a scan image obtained by scanning the paper document is displayed in the document image display area 801. An information display area 802 in the electronic transaction data registration screen 800 is an area to display various pieces of information in the electronic transaction data. A bottom portion of the electronic transaction data registration screen 800 includes a register button 804 and a cancel button 805.

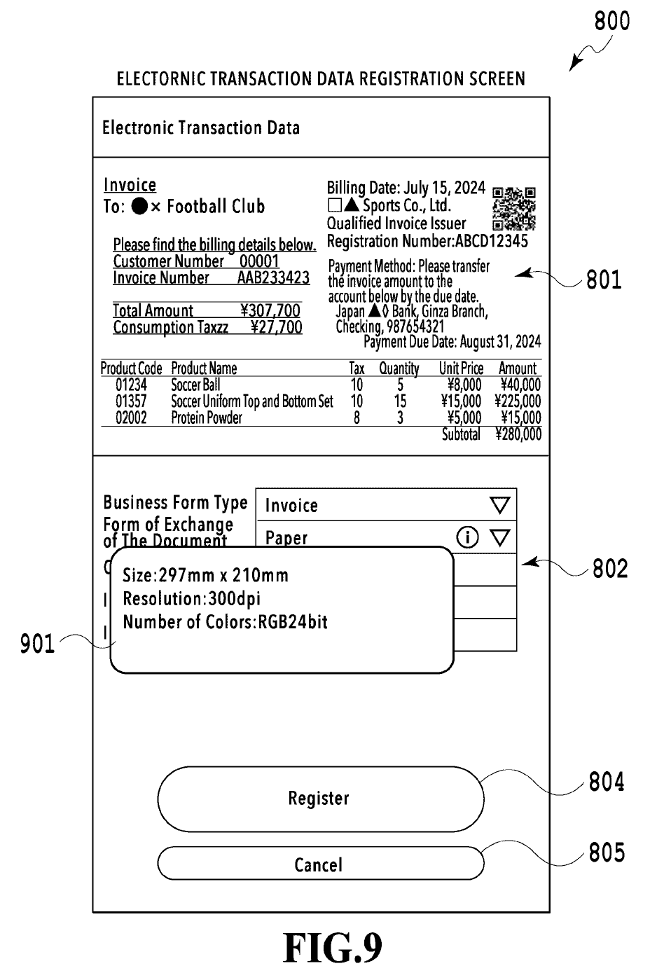

The information display area 802 includes an information icon 803. The CPU 311 of the document management server 120 generates the screen data of the electronic transaction data registration screen 800 such that an information dialog 901 (see FIG. 9) is displayed in a case where the information icon 803 is pressed.

FIG. 9 is a diagram illustrating an example of the information dialog 901. FIG. 9 is a screen displayed on the display unit 230 of the user terminal 110 in a case where the user presses the information icon 803 included in the electronic transaction data registration screen 800. The information dialog 901 displays information on the size of the document image represented by the target electronic transaction data and additionally the number of colors (number of tones) in the target electronic transaction data and its resolution. The number of colors (number of tones) and the resolution included in the information dialog 901 are a number of colors (number of tones) and a resolution obtained from the properties of the target electronic transaction data in the analysis process performed on the target electronic transaction data by the document management server 120.

In a case where the user presses an area outside the information dialog 901, the electronic transaction data registration screen 800 transitions to the one on which the information dialog 901 is not displayed, as illustrated in FIG. 8.

Note that, on the electronic transaction data registration screen 800 in the present embodiment, the information icon 803 is displayed regardless of whether the form of exchange is "paper" or "electronic." Alternatively, the information icon 803 may not be displayed in a section 806 for the form of exchange in the electronic transaction data registration screen 800 in a case where the form of exchange of the electronic transaction data is judged to be "electronic." Specifically, the document management server 120 may generate the screen data of the electronic transaction data registration screen 800 including the information icon 803 to display the number of tones and resolution as requirements for scanner storage only in a case where the form of exchange is judged to be "paper." A list of forms of exchange may be displayed in a case where the user presses the dropdown button included in the section 806 for the form of exchange. Then, the user may change the form of exchange in a case where the user selects a form of exchange from that list.

Also, the information dialog 901 may be displayed without the information icon 803 being pressed. In a case where the operation unit 220 of the user terminal 110 is a mouse, the document management server 120 may generate the screen data such that the information dialog 901 is displayed in a superimposed manner simply in a case where the mouse pointer is hovered over the information icon 803.

The user can easily whether the electronic transaction data satisfies the requirements for scanner storage form the information displayed in the information dialog 901 included in the electronic transaction data registration screen 800. The user may press the register button 804 if determining that the electronic transaction data satisfies the requirements for scanner storage, and press the cancel button 805 if determining that the electronic transaction data does not satisfy a requirement or requirements. In a case where the cancel button 805 is pressed, the processing is canceled, followed by generating electronic transaction data and performing the processing from S501 again.

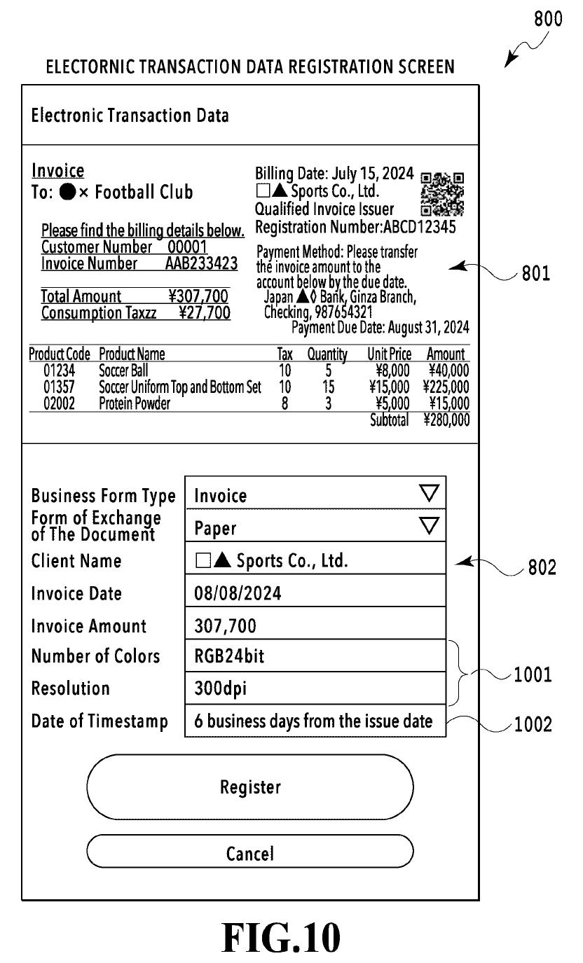

FIG. 10 is a diagram for describing another example of the electronic transaction data registration screen 800. The information display area 802 in FIG. 10 includes an area 1001 to display the resolution and the number of colors (number of tones). Information such as the resolution and the number of tones, which are requirements for scanner storage, may be initially displayed on the electronic transaction data registration screen 800 as described above. On an electronic transaction data registration screen 800 as illustrated in FIG. 8 mentioned earlier, the amount of information display is small, thus saving the user the trouble of finding necessary information. On the other hand, an electronic transaction data registration screen 800 as illustrated in FIG. 10 can saves the user the effort of pressing the information icon 803 to check the resolution and the number of tones.

Further, the electronic transaction data registration screen 800 in FIG. 10 includes an area 1002 to display the period from the issue date of the invoice to the date of the timestamp. As described above, the document management server 120 may generate the screen data such that the information used in the judgment in S709 is displayed on the electronic transaction data registration screen 800 or in the information dialog 901.

In S510, the CPU 211 of the user terminal 110 accepts a press on the register button 804.

In S511, the CPU 211 of the user terminal 110 instructs the document management server 120 to register the electronic transaction data.

In S512, the CPU 311 of the document management server 120 stores the electronic transaction data transmitted from the user terminal 110 in S505 in the database 302.

As described above, according to the present embodiment, the user can easily check whether electronic transaction data to be registered in the document management server 120 satisfies the requirements for scanner storage. Also, in a case of storing a paper document in the form of electronic data even if it is not required to do so by law, the user may desire to store the document as an image with appropriate image quality so that the stored document can be easily checked. Even in such a case, according to the present embodiment, the user attempting to store the electronic data can quantitatively check whether the image quality of the electronic data to be stored is suitable for storage since the resolution and the number of tones are displayed.

### Second Embodiment

In a second embodiment, a description will be given of a method that changes the electronic transaction data registration screen depending on whether the electronic transaction data selected by the user satisfies the requirements for scanner storage or the electronic transaction data does not satisfy the requirements. In the present embodiment, its difference from the first embodiment will be mainly described. Features that are not particularly specified are the same components and processes as those in the first embodiment. The same components as those in the first embodiment will be denoted by the same reference signs in the drawings, and description thereof will be omitted.

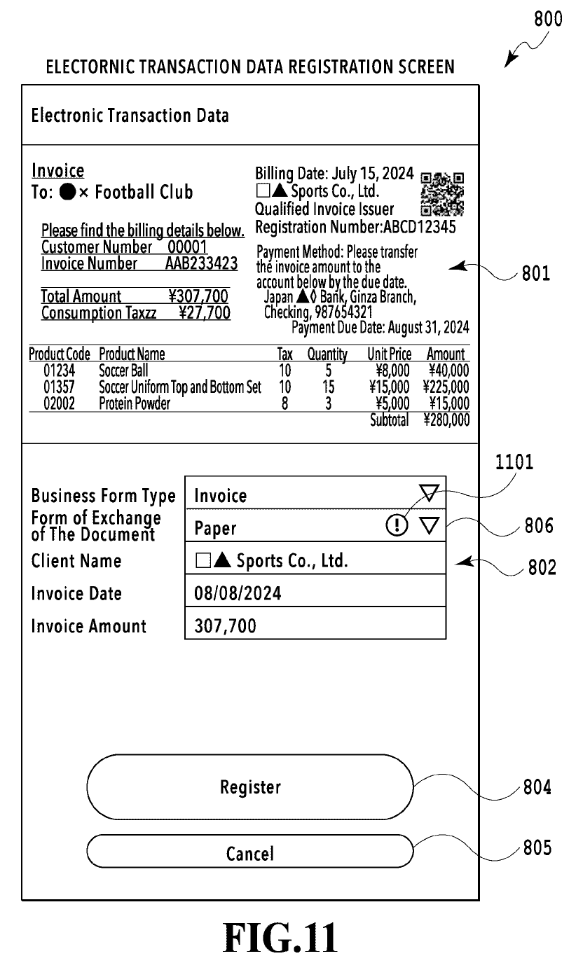

FIG. 11 is a diagram illustrating an example of the electronic transaction data registration screen 800 generated in S507 in a case where it is determined that the electronic transaction data received by the document management server 120 does not satisfy a requirement for scanner storage. In the present embodiment, in a case where the electronic transaction data does not satisfy a requirement for scanner storage, the icon displayed in the section 806 for the form of exchange in the electronic transaction data registration screen 800 is changed to a warning icon 1101. In a case where the electronic transaction data satisfies the requirements for scanner storage, an electronic transaction data registration screen 800 as illustrated in FIG. 8 including the information icon 803 in place of the warning icon 1101 is displayed.

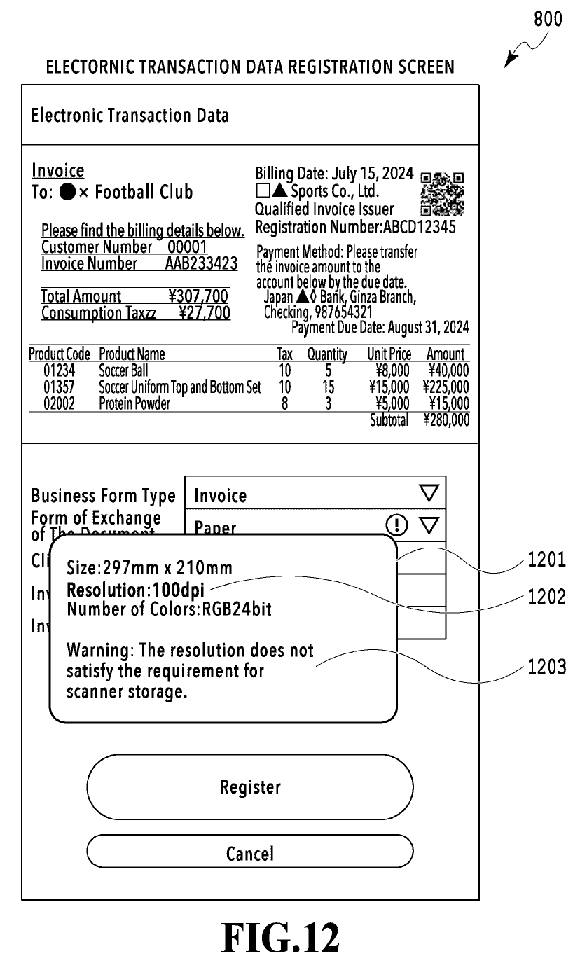

FIG. 12 is a diagram illustrating an example of a warning dialog displayed in a case where the user presses the warning icon 1101. Like the information dialog 901, the warning dialog 1201 displays information on the size of the document image represented by the target electronic transaction data and additionally the number of colors (number of tones) in the target electronic transaction data and its resolution. Here, unlike the information dialog 901, the warning dialog 1201 highlights the item judged not to satisfy the requirement, and includes a description 1203 indicating the cause of not satisfying the requirement. The description may indicate the requirement for scanner storage. In FIG. 12, due to the resolution being less than 200 dpi, a resolution area 1202 in the warning dialog 1201 is displayed with bold characters, highlighting the item not satisfying the requirement. Note that the highlighting method is not limited to displaying bold characters. The color may be changed, or the size may be changed.

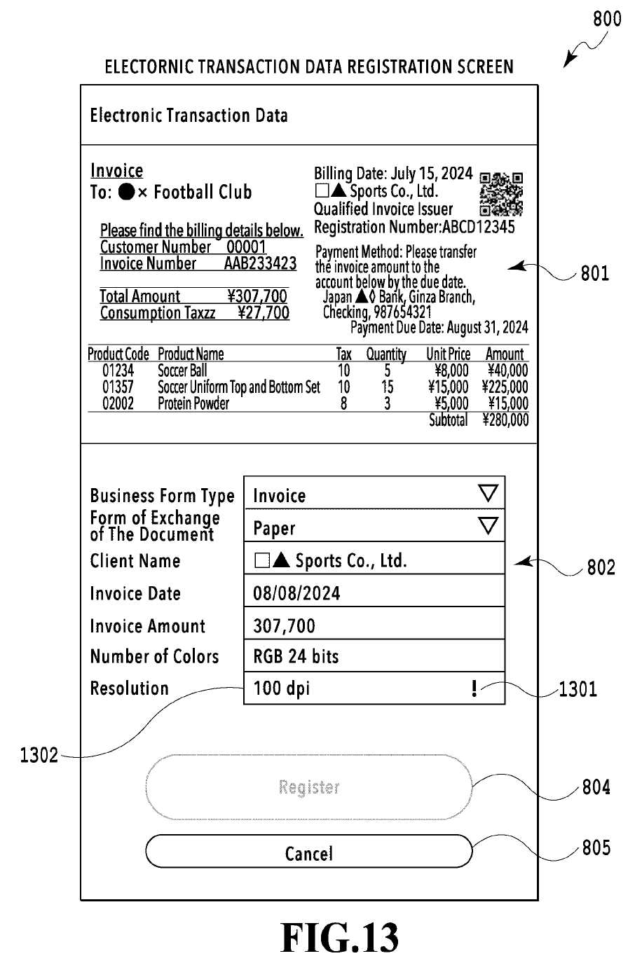

FIG. 13 is a diagram for describing another example of the electronic transaction data registration screen in the present embodiment. In the present embodiment too, the resolution and the number of tones may be additionally displayed in the information display area 802. In this case, a warning icon 1301 may be displayed in a section 1302 for an item judged not to satisfy the requirement. A warning dialog including a description 1203 may be displayed in a case where the warning icon 1301 is pressed. Also, the screen configuration may be such that, in a case where the electronic transaction data does not satisfy a requirement for scanner storage, the register button 804 is, for example, grayed out as illustrated in FIG. 13 so as not to accept a press on the register button 804.

As described above, according to the present embodiment, in a case where electronic transaction data does not satisfy a requirement for scanner storage, it is possible to notify the user that the electronic transaction data does not satisfy the requirement for scanner storage. Therefore, according to the present embodiment, it is possible to save the user the effort of checking.

### Other Embodiments

In the above-described embodiments, the CPU 311 of the document management server 120 has been described as generating screen data and analyzing electronic transaction data. Alternatively, the processes to be executed by the CPU 311 of the document management server 120 may be executed by the CPU 211 of the user terminal 110.

Also, the present disclosure includes systems configured by appropriately combining the above-described embodiments and the functions of those systems.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No.2025-042723, filed Mar. 17, 2025, which is hereby incorporated by reference herein in its entirety.

What is claimed is:

1. An information processing apparatus comprising:
a reception unit configured to receive electronic data of an image representing a document selected by a user;
a first obtaining unit configured to obtain information indicating a form of exchange of the document;
a second obtaining unit configured to obtain a resolution of the image and a number of tones of the image from the electronic data; and
a display control unit configured to perform a process of displaying the form of exchange, the resolution, and the number of tones to the user.

2. The information processing apparatus according to claim 1, wherein
the information indicating the form of exchange is information indicating whether the form of delivery is paper or electronic, and
the display control unit performs a process of displaying the resolution and the number of tones in a case where the form of exchange is paper, and not displaying the resolution and the number of tones in a case where the form of exchange is electronic.

3. The information processing apparatus according to claim 1, wherein
the second obtaining unit obtains the resolution and the number of tones from properties of a file representing the electronic data.

4. The information processing apparatus according to claim 1, further comprising
a determination unit configured to obtain information on an application which generated the electronic data from properties of a file representing the electronic data, and determine whether the form of exchange of the document is paper or electronic based on the information on the application, wherein
the first obtaining unit obtains information indicating the form of exchange determined by the determination unit.

5. The information processing apparatus according to claim 1, further comprising
a judgment unit configured to judge whether the electronic data satisfies a requirement for scanner storage, wherein
the display control unit provides a notification to the user in a case where the form of exchange is paper and the requirement is not satisfied.

6. The information processing apparatus according to claim 1, wherein
the display control unit provides a notification to the user in a case where the form of exchange is paper and at least one of the resolution or the number of tones is not a predetermined value or more.

7. The information processing apparatus according to claim 1, further comprising:
an extraction unit configured to recognize a group of character strings included in the image and extract a character string indicating an issue date of the document from the group of character strings; and
a third obtaining unit configured to obtain a date of a timestamp from the electronic data, wherein
the display control unit provides a notification to the user in a case where the form of exchange is paper and a difference between the issue date and the date of the timestamp is not a predetermined number of days or less.

8. The information processing apparatus according to claim 5, wherein
the display control unit provides the notification to the user by changing display of a screen.

9. The information processing apparatus according to claim 1, wherein
the display control unit displays a screen including the form of exchange and including neither the resolution nor the number of tones, and displays the resolution and the number of tones in response to an operation on a predetermined area included in the screen.

10. The information processing apparatus according to claim 9, wherein
the display control unit displays the resolution and the number of tones in response to a mouseover over the predetermined area.

11. The information processing apparatus according to claim 1, wherein
the display control unit performs a process of displaying the form of exchange, the resolution, and the number of tones on a terminal being used by the user.

12. The information processing apparatus according to claim 1, wherein
in a case where the electronic data is data of a scan image obtained by scanning a paper document, the resolution and the number of tones are a resolution and a number of tones for the scanning of the document.

13. An information processing method comprising:
receiving electronic data of an image representing a document selected by a user;
obtaining information indicating a form of exchange of the document;
obtaining a resolution of the image and a number of tones of the image from the electronic data; and
displaying the form of exchange, the resolution, and the number of tones to the user.

14. A non-transitory computer readable storage medium storing a program which causes a computer to perform an information processing method, the information processing method comprising:
receiving electronic data of an image representing a document selected by a user;
obtaining information indicating a form of exchange of the document;
obtaining a resolution of the image and a number of tones of the image from the electronic data; and
displaying the form of exchange, the resolution, and the number of tones to the user.
